(19) United States
(12) Patent Application Publication
(10) Pub. No.: US 2007/0051389 A1
(43) Pub. Date: Mar. 8, 2007

(54) Method and apparatus for substrate rinsing

(76) Inventor: Jalal Ashjaee, Cupertino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/218,385

(22) Filed: Sep. 2, 2005

(51) Int. Cl. B08B 3/00; B08B 7/00

(52) U.S. Cl. 134/33; 134/34; 134/26; 134/94.1; 134/149; 134/95.1

(57) ABSTRACT

A semiconductor substrate rinsing method and apparatus. A wet processed substrate is spun to reduce the amount of process solution on the surface of the substrate. The concentration of the process solution on the surface of the substrate is reduced by applying a cleaning solution to the surface. The cleaning solution may be applied from nozzles on a supply member positioned across from the surface of the substrate. The nozzles may be angled to evenly distribute application of the cleaning solution on the substrate.

### FIELD

The present invention generally relates to semiconductor integrated circuit technology and, more particularly, to an apparatus and process for rinsing substrates.

### BACKGROUND

Semiconductor device fabrication involves many wet processing steps in which substrates are exposed to processing solutions, including various chemicals. For example, metal layers can be formed on substrates using deposition electrolytes in electrochemical or electroless processes. Similarly, deposited metal layers can be removed or planarized using chemical mechanical polishing or electropolishing, both of which processes typically use oxidizing solutions. Further, unwanted portions of masking layers can be removed by means of wet development processing, involving chemical solutions. Surfaces of substrates are “cleaned” or “polished” by means of removing a thin layer, such as an oxidized layer, using appropriate chemical solutions.

After such wet processing steps, however, substrates need to be rinsed off, typically with de-ionized water (DI water), so that the chemical residues are removed from the substrate before a subsequent process step. Chemical residues left on the substrate would continue interaction with the substrate material, resulting in corrosion or defects that lower device performance or cause device failures.

While it is important to clean or rinse chemical residues from substrates, it is also important, for productivity reasons, to do this process as quickly and with as little de-ionized water as possible. Therefore, in the semiconductor industry, there is always a need for more efficient rinsing or cleaning of substrates.

### SUMMARY

According to an aspect of the invention, a method is provided for rinsing a surface of a wafer using a cleaning solution. The surface of the wafer is treated using a process solution. The cleaning solution is applied to the surface to form a first mixture including a first concentration of the process solution. The wafer is spun to reduce an amount of the first mixture on the surface. The cleaning solution is applied to the surface to form a second mixture including a second concentration of the process solution, wherein the second concentration is less than the first concentration. The wafer is spun to remove the second mixture from the surface.

According to another aspect of the invention, an apparatus is provided for rinsing a surface of a wafer using a rinsing solution after a wet process. The apparatus includes a solution supply member, a plurality of nozzles, and at least one moving mechanism. The solution supply member is positioned across from the surface of the wafer. The plurality of nozzles is disposed on the solution supply member and distributed to inject a substantially uniform amount of the rinsing solution onto both an edge region and a central region of the surface of the wafer. The at least one moving mechanism is configured to laterally move at least one of the wafer and the solution supply member as the solution is injected onto the surface of the wafer.

### BRIEF DESCRIPTION OF THE DRAWINGS

These and other aspects of the invention will be readily apparent from the following description and from the appended drawings (not to scale), which are meant to illustrate and not to limit the invention, and wherein:

FIG. 1 is a schematic illustration of a wafer held by a wafer carrier after a process, wherein the surface of the wafer includes a film of a residual process solution in an embodiment;

FIG. 2 is a schematic illustration of applying a rinsing solution to the surface of the wafer shown in FIG. 1;

FIGS. 3A and 3B are schematic illustrations of rinsing solution jets impinging on the surface of the wafer as the wafer or the solution supply is moved laterally;

FIG. 4 is a schematic illustration of a solution mixture formed on the surface of the wafer by the application of rinsing solution;

FIG. 5 is a schematic illustration of another solution mixture formed on the surface of the wafer by the application of rinsing solution and spinning the wafer;

FIG. 6 is a schematic illustration of the wafer after the rinsing process;

FIG. 7 is a schematic illustration of the wafer after a drying process;

FIGS. 8A and 8B are schematic illustrations of an embodiment of a solution supply member;

FIGS. 9A and 9B are schematic illustrations of another embodiment of the solution supply member of the present invention;

FIG. 10 is a schematic illustration of a rinsing station including the solution supply member of an embodiment; and

FIG. 11 is a schematic illustration of a vertical system including a process station and a rinsing station, including the solution supply member of an embodiment.

### DETAILED DESCRIPTION

The following detailed description of the preferred embodiments and methods presents a description of certain specific embodiments to assist in understanding the claims. However, one may practice the present invention in a multitude of different embodiments and methods as defined and covered by the claims.

An embodiment provides a method and apparatus for rinsing substrates, using a liquid such as DI water, or another liquid. In one embodiment, a substrate or wafer surface is contacted with a plurality of high velocity liquid jets or streams of a liquid, which are directed from a plurality of openings of a supply member. By moving at least one of the supply member and the wafer, every point on the wafer surface is contacted with the high velocity liquid jets. In a second embodiment, a wafer, which was previously treated with a liquid, is substantially drained by spinning the wafer one or more times at high speeds for a short period during the rinsing process. In a third embodiment, an embodiment of a supply member is provided. The openings of the supply member, which produce the high velocity liquid jets, are preferably distributed such that the coverage is substantially uniform. The substrate is typically dried before moving to the next processing step. Sometimes the rinsing and drying steps are performed in a processing module specifically designed for rinsing and drying the substrate.

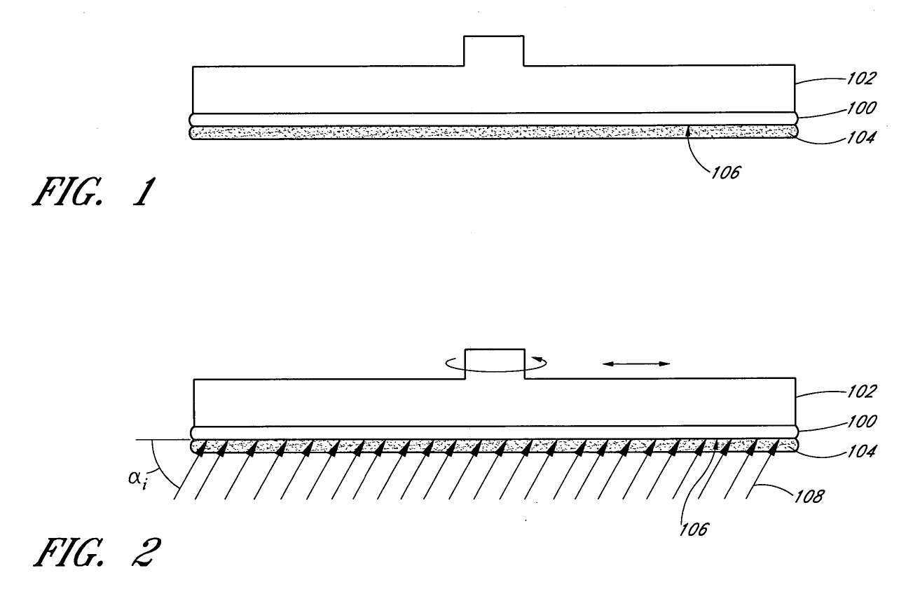

FIGS. 1 to 6 illustrate an exemplary rinsing process according to an embodiment, including liquid application and draining steps, upon a wet-processed wafer. In this embodiment, a rinsing process is performed using DI water to clean a wet-processed wafer. FIG. 1 illustrates a wafer 100 held by a wafer carrier 102 for the rinsing process of this embodiment. The wafer 100 may be a wet processed wafer having a first film 104 of a process solution on a front surface 106 of the wafer 100. The front surface 106 may be made of a metal, semiconductor, or a dielectric, or a combination of different materials, depending upon the stage of IC fabrication. The first film 104 may be formed of process solution and any byproduct left on the surface 106 of the wafer 100. The wet process performed on the wafer 100 may be any electrochemical process or electroless process, or other deposition, removal or surface treatment process. The rinsing process of this embodiment cleans off the process solution film 104 so that the surface 106 can be further processed in a subsequent process step. The process solution forming the first film 104 may be an electrolyte or an electropolishing solution including various chemicals that are desirably removed from the surface 106 of the wafer 100 before a subsequent process step. In FIG. 1, the film 104 is illustrated with densely distributed dots representing chemicals or other materials that are desirably cleaned off using the process of this embodiment. In the figures, the density of the dots is gradually reduced to help visualization of the removal of such chemicals from the surface 106 during the rinsing process.

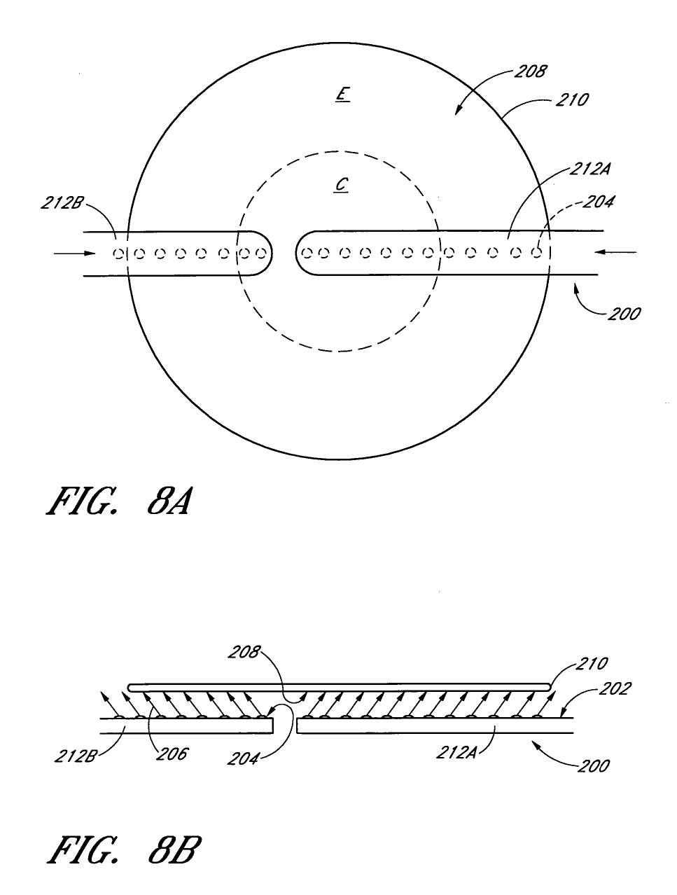

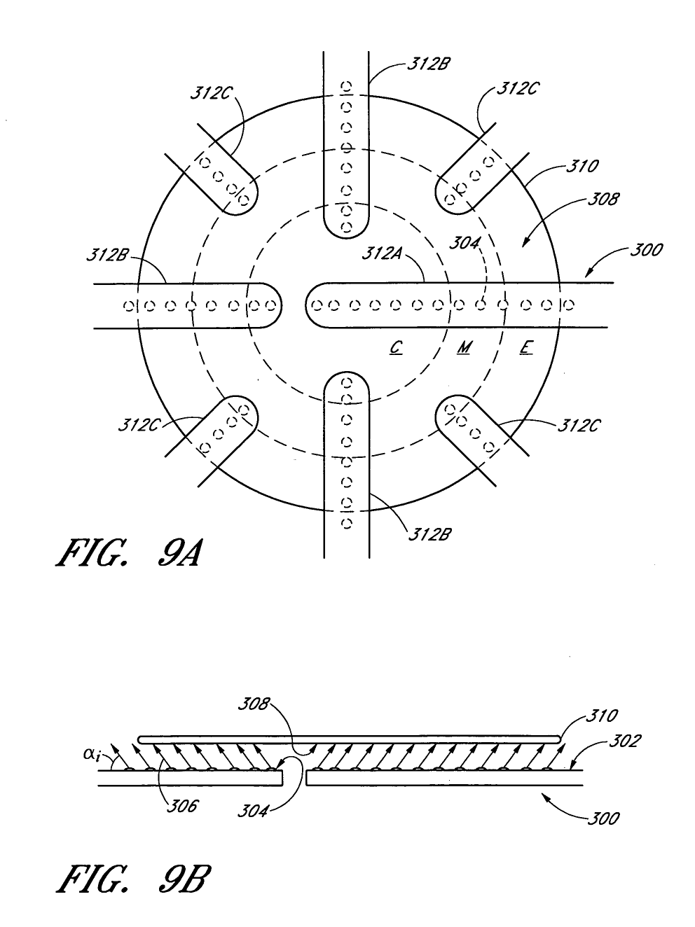

FIG. 2 shows a liquid application step of this embodiment. In this step, jets of DI water or other rinsing solution depicted by arrows 108 are applied to the first film 104 on the front surface 106. Jets 108 of DI water penetrate into the film 104 and impinge on the front surface 106 with high momentum. As the jets 108 are breaking the film 104 apart, the process solution forming the first film 104 begins mixing with the DI water. DI water jets 108 preferably penetrate below the fluid boundary layer substantially everywhere on the front surface 106. As will be described below, this mixing, in turn, forms a mixture of DI water and the first film 104 or the chemicals of first film 104, including constituents of the preceding wet process solution. In a preferred embodiment, a large number of jets 108, typically from 50 to 150 jets for a 300-mm diameter wafer, are used to apply the DI water to the front surface 106. As shown in FIG. 2, the jets 108 are preferably slanted at an angle so that they arrive at the front surface 106 under an impact angle (aᵢ) which is preferably 30°-60°. The diameter of the water jets is typically between 0.2 to 0.4 mm. The velocity of the jets 108 is preferably between 0.5 to 2.5 m/sec. The jets 108 may be directed from a supply member 200, 300, as exemplified in FIGS. 8A-9B.

Referring to FIG. 2, in order to have full coverage on the front surface 106, during the liquid application step, the wafer 100 is preferably rotated at rotational speeds ranging from 30 to 120 rpm, and reciprocated linearly in a horizontal dimension by about 2-4 mm at each 1 to 5 cycles per second. The jets 108 are preferably distributed such that the coverage on the front surface 106 is substantially uniform.

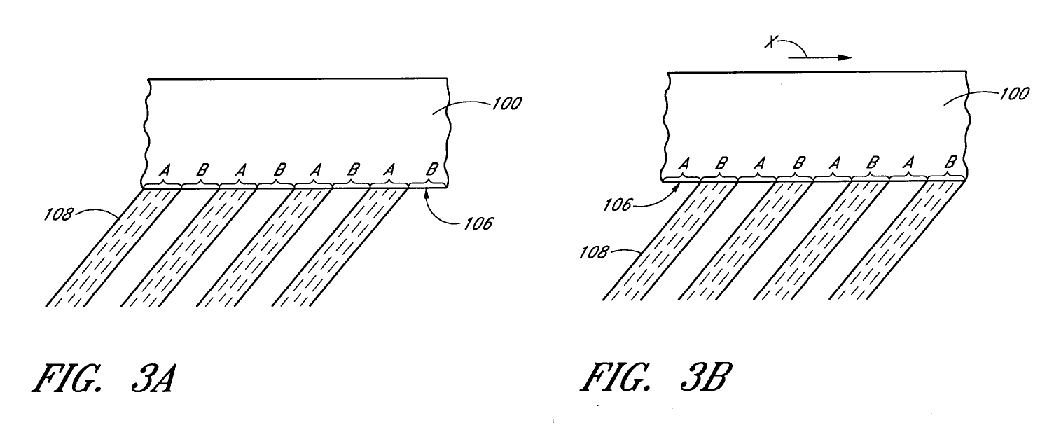

As shown in FIGS. 3A and 3B, in one embodiment, full coverage on the front surface 106 may be established dynamically by laterally moving the wafer 100 as the wafer 100 is rotated. Referring to FIG. 3A, at a first lateral position and for a first predetermined number of rotations, the jets 108 impinge on spots denoted by ‘A’ on the front surface 106. As shown in FIG. 3B, at the end of the first predetermined number of rotations, the wafer 100 is laterally moved to a second lateral position in the direction of arrow ‘X’. At the second position, the jets 108 impinge on the spots denoted by ‘B’ adjacent the spots ‘A’ for a second predetermined number of rotations; thus, the front surface 106 is fully treated with the DI water. In other embodiments, the full coverage may be established by laterally moving the wafer 100 among more than two lateral positions. In one embodiment, the wafer 100 continuously oscillates between two lateral positions while it is rotated simultaneously.

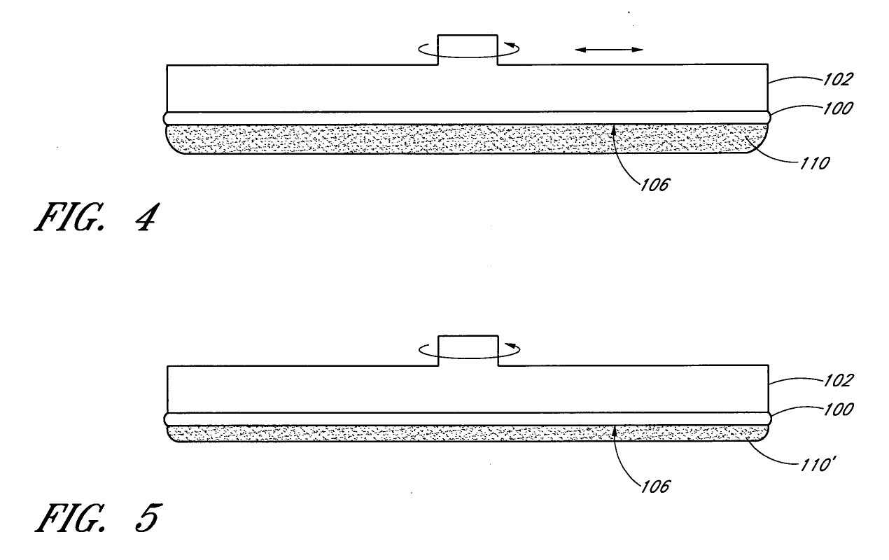

As mentioned above, as the front surface 106 is treated with jets 108, the process solution forming the first film 104 begins mixing with the DI water and forms a mixture of solutions on the surface 106 of the wafer 100. As shown in FIG. 4, application of the DI water jets to the front surface 106 forms a second film 110 comprising a diluted mixture of the DI water and the process solution in the first film 104. Although, in FIG. 4, the second film 110 is shown to be thicker than the first film 104 of FIG. 1, the second film 110 can be thinner or equal to the thickness of the first film 104. According to this embodiment, the second film 110 is a mixture including DI water and the chemicals of the first film 104. In this embodiment, the second film 110 is a dynamic environment where fresh DI water continuously arrives with the jets 108 and gets mixed with the existing mixture of process solution from the first film 104 and the already applied DI water, while at the same time the mixture is continuously drained by the motion of the wafer carrier 102 and the gravity. As a result, the amount of process solution or the concentration of the chemicals from the process solution in the second film 110 is continuously and significantly reduced as the jets 108 are applied to the front surface 106 for a predetermined time. In FIG. 4, dilution of the process solution in the DI water is represented by less densely distributed dots in the second film 110.

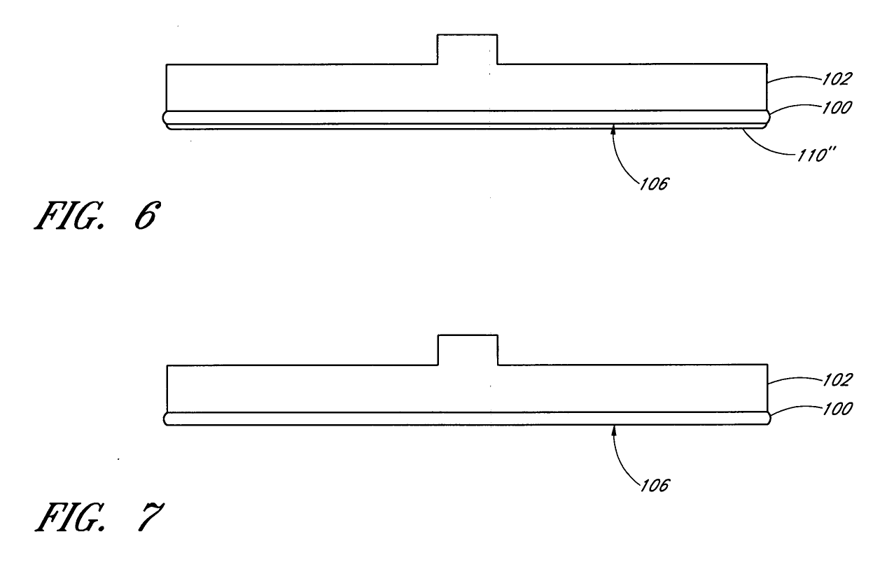

FIGS. 5 and 6 illustrate exemplary stages during the draining step of the rinsing process, according to an embodiment. During the draining step, the second film 110 is substantially drained one or more times by spinning the wafer 100 at higher speeds for a short period, preferably for about 0.5 to 3.0 seconds. The draining step may be performed by spinning the wafer 100 at high speeds for a short period and it will be understood that the short period of spinning may be performed more than once and also by accelerating and/or decelerating. The draining speed is preferably from 400 to 1200 rpm for a short period of time, preferably about 0.5 to 3.0 seconds and acceleration/deceleration from and to the rinsing speed is achieved preferably in less than 2 seconds.

In one embodiment, the draining step and liquid application step can be applied sequentially to increase rinsing efficiency. In this embodiment, first the DI water jets are applied to the second film 110 shown in FIG. 4 while the wafer 100 is rotated and laterally moved. Liquid application in this manner reduces the concentration of chemicals in the second film 110. Second, the DI water jets are stopped and spinning of the wafer 100 is increased to draining speed (e.g., about 400-1200 rpm) for efficient draining of the diluted second film 110, which reduces the amount of mixed solution on the surface 106 of the wafer 100. As the spinning speed of the wafer 100 is reduced, an intermediate phase 110′ of the second solution 110 may be left on the front surface 106 of the wafer 100, as shown in FIG. 5. The intermediate phase 110′ shown in FIG. 5 is only an exemplary illustration and may be formed after one or more liquid application and draining steps. As shown in FIG. 5 with the density of the dots in the intermediate phase 110′, the concentration of the process solution or the chemicals in DI water is highly reduced in the small volume of the intermediate phase 110′ in this stage. If the application of DI water to the intermediate phase 110′ and draining steps are repeated one or more times, a final phase 110″ of the second film 110 is obtained, as shown in FIG. 6. The final phase 110″ includes a volume of DI water with almost no process solution or chemicals in it. After this step, as shown in FIG. 7, the wafer 100 is dried to remove the final phase 110″ from the front surface 106. The rinsing process of this embodiment removes the process solutions or the chemicals from wafer surface 106 in significantly shorter times and often with a smaller amount of DI water, which makes the rinsing more efficient.

The liquid application step of the rinsing process may be performed using supply members described below. A supply member 200 to produce DI water jets, as described above, is exemplified in FIG. 8A in a top plan view and in FIG. 8B in a side view. In this embodiment, although supply members 200 are used with DI water, it is understood that supply members 200 can be used with any liquid or cleaning solution. A first side 202 of the supply member 200 includes a plurality of nozzles or openings 204 to produce DI water jets 206 that impinge on a surface 208 of a wafer 210 during the rinsing process. The wafer surface 208 may have a process solution film (not shown) to be cleaned using the supply member 200 and the process of this embodiment. While, in this embodiment, the distribution of the nozzles 204 is such that full coverage of the DI water jets 206 on the wafer surface 208 is obtained, still the coverage may not be uniform since the amount of fresh DI water received, for example, near the edge region E of the wafer is substantially less than the amount received near the central region C of the wafer. In one distribution example, the nozzles 204 are disposed on a first arm 212A and a second arm 212B of the supply member 200 and preferably slanted towards the edge of the wafer. In the illustrated distribution example, the first arm 212A extends beyond the center of the wafer so that jets 206 from the nozzles 204 on the first arm 212A cover an edge region E and a central region C of the surface 208 as the wafer is rotated. In the illustrated embodiment, the second arm 212B only extends over an approximate border (dotted circle) between the edge and central regions so that the jets from the nozzles 206 on the second arm 212B cover only the edge region E as the wafer is rotated. The addition of the second arm 212B increases the number of jets treating the edge region E (two sets in region E vs. one set in region C), which is larger than the central region C; thus, in this embodiment, the rotating surface 208 is covered with better uniformity by the DI water jets 206.

FIGS. 9A-9B show another embodiment of a supply member 300 having a first side 302 including a plurality of nozzles 304 for producing DI water (or other fluid) jets 306. As shown in FIG. 9B, the supply member 300 is positioned across from a surface 308 of a wafer 310. In this embodiment, the supply member 300 includes a plurality of arms, including a primary arm 312A, secondary arms 312B and ternary arms 312C. As in the previous embodiment, in this embodiment with the same principle, the nozzles 304 are distributed on the arms 312A, 312B, 312C for coverage with substantial uniformity of the surface 308 by the DI water jets 306. Accordingly, in this embodiment, the primary arm 312A extends over an edge region E (largest region), a middle region M (smaller than E) and a central region (smaller than E and M). The secondary arms 312B extend over the edge region E and the middle region M. The ternary arms 312C extend over the edge region E. In this nozzle distribution configuration, as the wafer is rotated, the edge region E of the surface 308 is exposed to highest number of jets 306; the middle region M is exposed to fewer jets 306 than in the region E; and the central region C is exposed to the least number of jets 306. In this embodiment, the supply member 300 preferably has about 30-50 nozzles for a 300 mm diameter wafer. The jets 306 are preferably slanted so that they arrive at the front surface 308 under an impact angle (αᵢ), which is preferably about 30°-60°. The diameter of the water jets 306 is preferably between 0.2 to 0.4 mm. The velocity of the jets 306 is preferably between 0.5 to 2.5 m/sec.

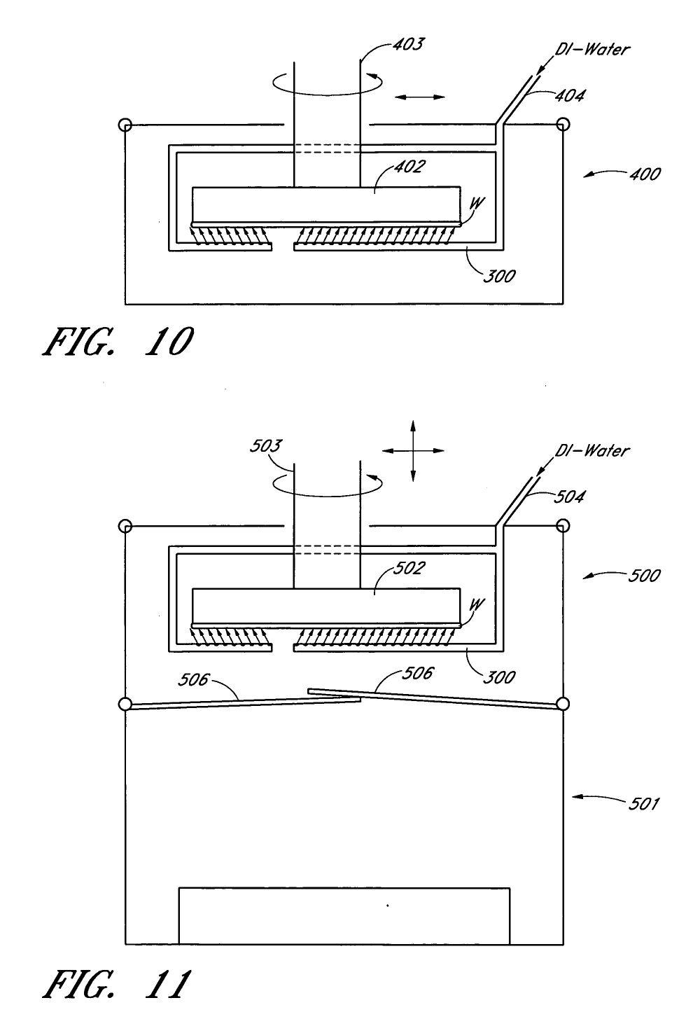

FIGS. 10 and 11 illustrate two rinsing station embodiments, using at least one of the supply members 200, 300 described above. FIG. 10 illustrates a single rinsing station 400 including a wafer holder 402 holding a wafer W to be rinsed using the supply member 300. The wafer holder 402 is preferably moved (laterally moved and/or rotated) through a shaft 403 that is connected to a moving mechanism (not shown). A solution line 404 is preferably attached to the supply member 300 to provide a liquid, such as rinsing solution or DI water. The station 400 may be an integral part of an electrochemical, electroless or chemical mechanical polishing system. Alternatively, the station 400 may be located outside such systems.

FIG. 11 shows a rinsing station 500 that is located over a process station 501 in a so-called vertical chamber arrangement. The rinsing station 500 also includes the supply member 300 for rinsing processed wafers. A solution line 504 is preferably attached to the supply member 300 to provide a liquid, such as rinsing solution or DI water. In the illustrated vertical chamber arrangement, a wafer W held by a wafer holder 502 can be processed in the process station 501 and rinsed in the rinsing station 500 by vertically moving the wafer W. In this embodiment, the wafer holder 502 can be moved vertically by extending or retracting the shaft 503. The process station 501 may perform any of a variety of processes, such as electrochemical, electroless or chemical mechanical polishing processes. Flaps 506 between the two stations 500, 501 open to allow the wafer holder 502 to move between the stations 500, 501 and also close to seal the process station 501 when the rinsing station 500 is in use.

In the systems of FIGS. 8A-11, one or more moving mechanisms (not shown) may rotate and/or laterally move the wafer W and/or supply member 300. Rinsing solution is preferably delivered from a solution tank connected to the solution lines 404, 504. In FIGS. 10 and 11, the solution line 404, 504 configurations are exemplary; it will be understood that they may be configured in various other ways.

Although various preferred embodiments and the best mode have been described in detail above, those skilled in the art will readily appreciate that many modifications of the exemplary embodiment are possible without materially departing from the novel teachings and advantages of this invention.

I claim:

1. A method of rinsing a surface of a wafer using a cleaning solution, comprising:
treating the surface of the wafer using a process solution;
applying the cleaning solution to the surface to form a first mixture including a first concentration of the process solution;
spinning the wafer to reduce an amount of the first mixture on the surface;
applying the cleaning solution to the surface to form a second mixture including a second concentration of the process solution, wherein the second concentration is less than the first concentration; and
spinning the wafer to remove the second mixture from the surface.

2. The method of claim 1 further comprising, after the step of spinning the wafer to remove the second mixture, applying the cleaning solution at least one more time, and spinning the wafer at least on more time.

3. The method of claim 1, further comprising drying the wafer after removing the second mixture.

4. The method of claim 1, further comprising applying the cleaning solution to the surface while spinning is performed.

5. The method of claim 1, wherein the wafer is rotated in the range of 400 to 1200 rpm during the spinning.

6. The method of claim 1, wherein the wafer is rotated in the range of 30 to 120 rpm while applying the cleaning solution.

7. The method of claim 1, wherein the cleaning solution is de-ionized water.

8. The method of claim 1, wherein applying comprises injecting the cleaning solution from a plurality of nozzles to the surface of the wafer.

9. The method of claim 8, wherein the cleaning solution is injected at a speed in the range of 0.5 to 2.5 meters per second.

10. The method of claim 8, wherein the plurality of nozzles is within the range of 30 to 50 nozzles for a 300 mm wafer.

11. The method of claim 8, further comprising injecting the cleaning solution at an angle so that the cleaning solution sweeps the surface in an outward direction on the surface.

12. The method of claim 11, wherein the angle of injection is in the range of 30° to 60° to the surface.

13. The method of claim 8, wherein at least one of the wafer and the plurality of nozzles is moved laterally during application of the cleaning solution.

14. The method of claim 13, wherein cleaning solution is applied to a first plurality of points on the surface before moving the plurality of nozzles laterally and cleaning solution is applied to a second plurality of points on the surface after moving the plurality of nozzles laterally, wherein the first and second plurality of points are different from each another.

15. The method of claim 1, further comprising holding the wafer with a wafer carrier.

16. The method of claim 1, further comprising laterally moving the wafer.

17. An apparatus for rinsing a surface of a wafer using a rinsing solution after a wet process, comprising:
a solution supply member positioned across from the surface of the wafer;
a plurality of nozzles disposed on the solution supply member and distributed to inject a substantially uniform amount of the rinsing solution onto both an edge region and a central region of the surface of the wafer; and
at least one moving mechanism configured to laterally move at least one of the wafer and the solution supply member as the solution is injected onto the surface of the wafer.

18. The apparatus of claim 17, wherein at least one moving mechanism is further configured to rotate at least one of the wafer and the solution supply member.

19. The apparatus of claim 17, wherein the rinsing solution is de-ionized water.

20. The apparatus of claim 17, wherein the solution supply member is comprised of a plurality of solution delivery arms.

21. The apparatus of claim 18, wherein the solution delivery arms comprise a first arm and a second arm, wherein the first arm extends over the central region and the second arm does not extend over the central region.

22. The apparatus of claim 20, wherein the solution delivery arms are distributed in a radial manner.

23. The apparatus of claim 22, wherein at least one of the plurality of solution delivery arms supplies rinsing solution only to the edge region of the surface of the wafer.

24. The apparatus of claim 17, wherein the nozzles are configured to inject the rinsing solution at an angle in the range of 30° to 60° to the surface.

25. The apparatus of claim 24, wherein the plurality of nozzles is angled outwardly towards the edge of the wafer.

26. The apparatus of claim 17, wherein a diameter of the nozzles is in the range of 0.2 to 0.4 mm.

27. The apparatus of claim 17, wherein the plurality of nozzles is configured to inject rinsing solution at a speed in the range of 0.5 to 2.5 m/sec.

28. The apparatus of claim 17, wherein the plurality of nozzles is within the range of 30 to 50 nozzles for a 300 mm wafer.

29. The apparatus of claim 17, wherein the plurality of nozzles is distributed such that a greater number of nozzles is configured to inject rinsing solution onto the edge region than a number of nozzles configured to inject rinsing solution onto the central region.
